(19) United States
(12) Patent Application Publication
(10) Pub. No.: US 2008/0182141 A1
(43) Pub. Date: Jul. 31, 2008

(54) Device and a method for operation of a high temperature fuel cell

(76) Inventors: Juergen Rechberger, Graz (AT); Martin Schuessler, Graz (AT); Peter Prenninger, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/902,956

(22) Filed: Sep. 26, 2007

(30) Foreign Application Priority Data
Oct. 3, 2006 (AT) A 1654/2006

(51) Int. Cl. H01M 8/06; H01M 8/04

(52) U.S. Cl. 429/17; 429/20

(57) ABSTRACT

The invention relates to a method and a device for operating a high-temperature fuel cell using liquid fuel, preferably diesel oil, where a reformer for the liquid fuel precedes the high-temperature fuel cell on the anode side. A recirculation line for the hot anode exhaust gas is provided, which departing from the outlet side of the anode of the high-temperature fuel cell leads to the inlet side of the reformer, an injector for spraying or injecting the liquid fuel into the hot anode exhaust gas being located upstream of a compressor preceding the reformer. The resulting cooling of the anode exhaust gas will permit the use of conventional positive displacement or rotary pumps in the anode circuit.

### BACKGROUND OF THE INVENTION

The invention relates to a device and a method for operation of a high-temperature fuel cell, which operates on liquid fuel, preferably diesel oil, and which is preceded by a reformer for the liquid fuel on the anode side.

High-temperature fuel cells using liquid fuel require an evaporation and reforming unit to convert the liquid fuel into a gaseous mixture which is suitable for the fuel cell.

### DESCRIPTION OF PRIOR ART

From WO 2005/005027 A1, for instance, there is known a high-temperature fuel cell associated with an internal combustion engine, e.g., a solid oxide fuel cell (SOFC) or a molten carbonate fuel cell (MCFC), which operates on the liquid fuel of the combustion engine. According to an embodiment shown in FIG. 3 the high-temperature fuel cell is preceded by a reformer and possibly by a desulphurization device. The anode effluent is used in the exhaust treatment of the internal combustion engine and is fed into a high-temperature and a low-temperature catalytic converter via metering valves, which are controlled by the electronic motor management unit. It is also possible to branch off a partial stream of the reformate produced by the reformer before the fuel cell and to add it to the anode effluent via a mixing valve, thus achieving an optimum composition of the reducing agent (for nitrogen oxides) used in the exhaust treatment of the internal combustion engine.

U.S. Pat. No. 5,208,114 A describes an energy generation device using a high-temperature fuel cell (MCFC). The anode of the fuel cell is preceded by a reformer, in which the fuel (natural gas) for the fuel cell is preprocessed. A recirculation line branches off at the outlet port of the anode of the fuel cell, as shown in a variant according to FIG. 8 or 9, which opens into the feeder line of the reformer after passing a blower and a heater unit, thus setting the reformer temperature. Problems which occur when liquid fuels are used, are not discussed in this document.

From DE 103 15 697 A1 a gas generation system with a reformer for generating a hydrogen-rich gas stream for the operation of a PEM-fuel cell is known, with gasoline or diesel oil used as fuel. According to one embodiment at least part of the anode exhaust gas is recycled into the anode circuit. To this end a recycling line for the anode effluent is provided, which—departing from the exit side of the anode of the PEM fuel cell—leads to a gas-jet pump or jet-pump at the entry side of the reformer.

The following problems arise:
Greatly fluctuating demand for reformed gas due to load changes of the fuel cell or the exhaust gas treatment unit will cause fluctuating pressure in the fuel cell and make high demands on reformer control (air/fuel ratio).
Efficiency of pure partial oxidation in the reformer (i.e., without addition of water) is low. Liquid water for efficient autothermal reforming with water, fuel and air is not available on board a vehicle.
Evaporation of liquid fuels, as for instance diesel oil, is advantageously performed by spraying them into a stream of carrier gas, for example the air which is required for reforming. Since the ratio of fuel to air is determined by the reformer process, the fuel must be evaporated in this relatively small air stream. This can only be achieved by complex and costly process engineering.
Complete evaporation and good mixing of evaporated fuel and carrier gas is essential for an optimum reformer process.

If anode recirculation, as described in the above mentioned U.S. Pat. No. 5,208,114 A or in DE 103 15 697 A1 is used, the following disadvantages arise in the case of high-temperature fuel cells:
Conventional pumps cannot be used to circulate hot gas streams.
A jet pump (injector) as driver for the anode circuit demands very low pressure losses in the anode circuit and has insufficient load dynamics.

### SUMMARY OF THE INVENTION

It is the object of the present invention to improve a device or a method for operating a high-temperature fuel cell using liquid fuel, and preferably diesel oil, in such a way that conventional pumping means for the gas streams may be employed, the system being able to respond quickly to load changes or fluctuations in reformate demand.

The invention achieves this aim by providing that at least part of the hot anode exhaust gas is recycled in the anode circuit, and that the liquid fuel is injected or sprayed into the hot anode exhaust gas upstream of a compressor preceding the reformer, in such a way that the fuel is completely evaporated and the mixture of anode exhaust gas and fuel is cooled before it enters the compressor.

A device implementing the method of the invention is characterized by providing a recirculation line for the hot anode exit gas, which departing from the outlet side of the anode of the high-temperature fuel cell leads to the inlet side of the reformer, an injector for spraying or injecting the liquid fuel into the hot anode exhaust gas being provided upstream of a compressor preceding the reformer.

For anode gas recirculation a conventional positive displacement pump or a rotary pump may be used to advantage. The required decrease in the temperature of the gas mixture to be pumped is achieved due to the spraying and evaporation of the fuel in the hot anode exhaust gas of the high-temperature fuel cell, for instance a molten carbonate fuel cell (MCFC) or a solid oxide fuel cell (SOFC).

The temperature of the pumped gas stream is thereby reduced from about 650° C. to about 400° C. In addition, the amount of air required for reforming the liquid fuel may be added to the mixture of anode exhaust gas and fuel prior to compression, which will result in a further temperature decrease.

As an alternative to direct cooling by adding air, the mixture of anode exhaust gas and fuel may be cooled in a heat exchanger prior to entering the compressor, preferably with the help of the amount of air required for reforming the liquid fuel. This will avoid a large gas volume of ignitable mixture prior to reaction in the reformer.

According to a particularly advantageous variant of the invention the reformate gas produced by the reformer may additionally be used for the exhaust gas treatment in a conventional internal combustion engine. The reformate gas may be passed through the fuel cell in excess and may be delivered downstream to the exhaust gas treatment system.

### BRIEF DESCRIPTION OF THE DRAWINGS

The invention will be further described below, with reference to the enclosed schematic drawings. There is shown in

FIG. 1 a first variant of a device according to the invention for operating a high-temperature fuel cell with liquid fuel;

FIGS. 2 and 3 a second and third variant of the invention;

FIG. 4 a control scheme for the variant of FIG. 1; and

FIGS. 5 and 6 a fourth and fifth variant of the device according to the invention.

### DETAILED DESCRIPTION OF THE PREFERRED EMBODIMENTS

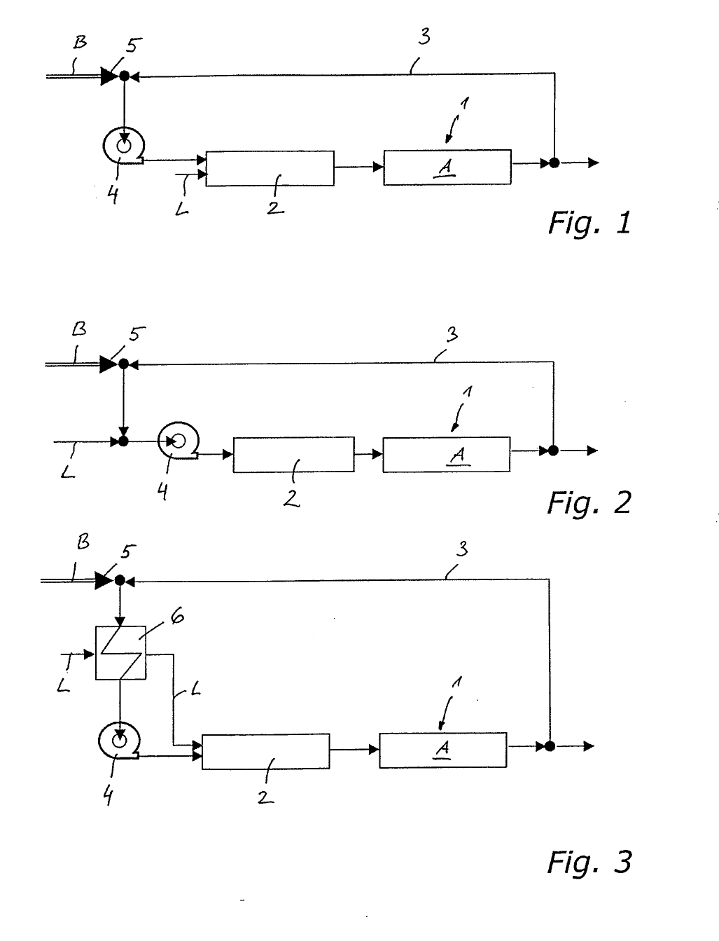

The device for operating a high-temperature fuel cell 1 with liquid fuel B, schematically shown in FIG. 1, has on the entry side of the anode A (the simplified drawing shows only anode A of the high-temperature fuel cell 1 or the fuel cell stack) a reformer 2 for the liquid fuel (liquid hydrocarbon, e.g., diesel oil). There is further provided a recirculation line 3 for the hot anode exhaust gas, which, departing from the exit side of the anode A of the high-temperature fuel cell 1, leads to the input side of the reformer 2. An injector 5 for injecting or spraying the liquid fuel B into the hot anode exhaust gas is located upstream of a compressor 4 preceding the reformer 2. The reformer 2 furthermore is provided with an inlet for the amount of air L required for reforming the fuel.

In the variant according to FIG. 2 the amount of air L required for reforming the liquid fuel is added to the mixture of anode exhaust gas and fuel upstream of the compressor 2.

In contrast to variant 2 in the variant of FIG. 3 the air L required for reforming is passed through a heat exchanger 6, which cools the mixture of anode exhaust gas and fuel without increasing the gas volume.

Early injection and passage through the compressor 4 will ensure thorough mixing. Due to the high temperature of the carrier gas and the properly controlled gas flow in the circuit complete evaporation of the fuel B is achieved.

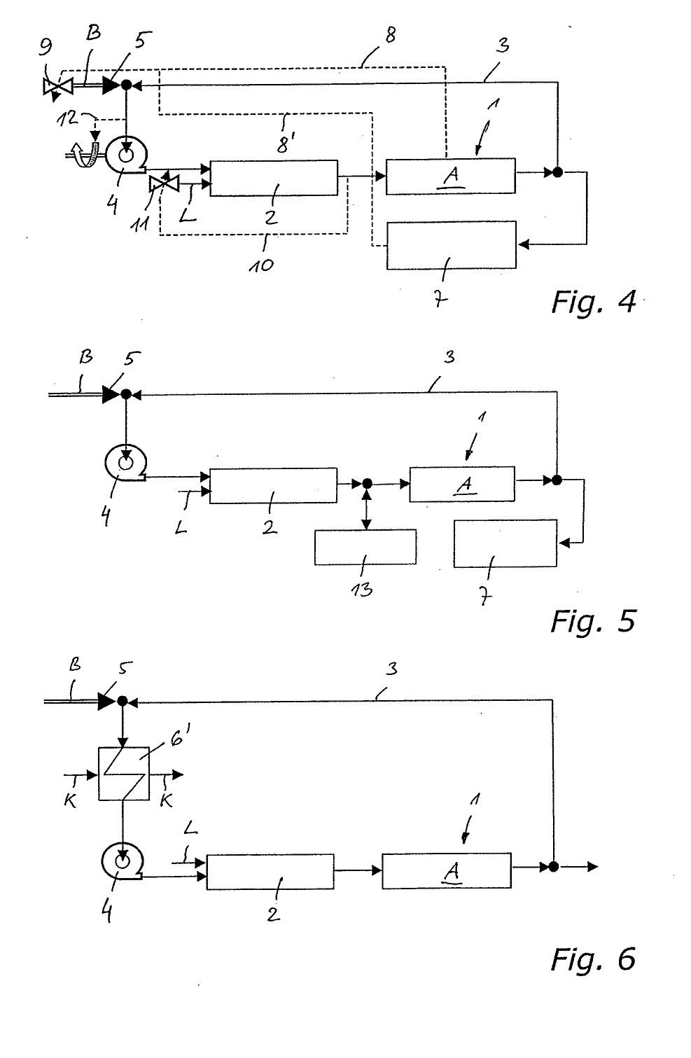

The control scheme as indicated in FIG. 4 proposes
that the amount of liquid fuel B sprayed or injected is controlled by the power demand of the high-temperature fuel cell 1 and possibly by the demand for reformate gas in the following exhaust gas treatment unit 7 (of an internal combustion engine) (see control loop 8, 8′ and control valve 9);
that the exit temperature of the gas produced by the reformer 2 is controlled by means of the amount of air L fed into the reformer 2 (see control loop 10 and control valve 11); and
that the entry temperature into the compressor 4 is set by the controlled speed of a positive displacement pump or a rotary pump within a range of 150° C. to 300° C. (see control loop 12).

A sudden stepwise change in the power of the high-temperature fuel cell 1 or the demand for reformate in the exhaust gas treatment unit 7 will place a heavy dynamic burden on the anode circuit. A substantial improvement may be achieved by providing an intermediate storage tank 13 for the reformate between the outlet of the reformer 2 and the inlet of anode A of the high-temperature fuel cell 1. This storage tank can for a short period of time meet the increased demand of the fuel cell and/or the exhaust gas treatment unit. During these few seconds the feeder units of the reformer (fuel pump, air compressor) can be brought to the new operating point and the demand for reformate can be fulfilled. The system can thus react dynamically to changes of electrical load or changes in reformate demand of the exhaust gas treatment unit.

If very large mass flows must be pumped through the recirculation line 3 of the anode circuit, cooling by fuel evaporation and air dilution will not be sufficient to allow the use of a conventional positive displacement or rotary pump for the compressor 4. In this case additional, external cooling (such as a heat exchanger 6′ with a liquid or gaseous cooling medium K) must be provided (FIG. 6). This will permit pumping of large mass flows around the circuit without introducing additional fuel or air. This is a very effective means of protecting the anode A against intruding oxygen (nickel oxidizing) and of guaranteeing rapid load adaptation by the fuel cell. By metered addition of small amounts of air cooling off of the anode A can be avoided since the oxygen is immediately oxidized in the reformer 2 (exothermal reaction). If this state is to be maintained for a prolonged period of time, small amounts of fuel must also be added in order to maintain a reducing environment in the anode circuit.

Via the anode circuit water may be continuously supplied to the gas produced by the reformer. This will increase the H/C and O/C ratio and thus efficiently suppress soot formation with its problems regarding service life.

What is claimed is:

1. A method for operating a high-temperature fuel cell, which operates on liquid fuel and is preceded on the anode side by a reformer for the liquid fuel, wherein at least part of the hot anode exhaust gas is recirculated in the anode circuit, and the liquid fuel is sprayed or injected into the hot anode exhaust gas upstream of a compressor preceding the reformer, such that the fuel is completely evaporated and the mixture of fuel and anode exhaust gas is cooled prior to entering the compressor.

2. A method according to claim 1, wherein the amount of air required for reforming the liquid fuel is added to the mixture of fuel and anode exhaust gas prior to compression.

3. A method according to claim 1, wherein the mixture of fuel and anode exhaust gas is cooled in a heat exchanger prior to entering the compressor, using the amount of air required for reforming the liquid fuel.

4. A method according to claim 1, wherein the amount of liquid fuel sprayed or injected into the hot anode exhaust gas is controlled by the performance requirements of the high-temperature fuel cell

5. A method according to claim 1, wherein the amount of liquid fuel sprayed or injected into the hot anode exhaust gas is controlled by the amount of reformate needed for a subsequent exhaust gas treatment unit.

6. A method according to claim 1, wherein the exit temperature of the reformate from the reformer is controlled by the amount of air fed to the reformer.

7. A method according to claim 1, wherein the entry temperature into the compressor is set in the range from 150° C. to 300° C. by means of the adjustable speed of a positive displacement pump or rotary pump.

8. A method according to claim 1, wherein the reformate gas supplied by the reformer is additionally used for the exhaust gas treatment of a conventional internal combustion engine.

9. A method according to claim 1, wherein the liquid fuel is diesel oil.

10. A device for operating a high-temperature fuel cell with liquid fuel with a reformer for the liquid fuel preceding the high-temperature fuel cell on the anode side, wherein a recirculation line for the hot anode exhaust gas is provided, which departing from the outlet side of the anode of the high-temperature fuel cell leads to the inlet side of the reformer, an injector for spraying or injecting the liquid fuel into the hot anode exhaust gas being located upstream of a compressor preceding the reformer.

11. A device according to claim 10, wherein the compressor is a conventional positive displacement pump or rotary pump.

12. A device according to claim 10, wherein an intermediate storage tank for the reformate is provided between the outlet of the reformer and the inlet of the anode of the high-temperature fuel cell.

13. A device according to claim 10, wherein the high-temperature fuel cell is a molten carbonate fuel cell (MCFC) or a solid oxide fuel cell (SOFC).
